(19) United States
(12) Patent Application Publication
(10) Pub. No.: US 2021/0400351 A1
(43) Pub. Date: Dec. 23, 2021

(54) ON DEMAND VIRTUAL A/V BROADCAST SYSTEM

(71) Applicant: Eagle Eyes Vision, LLC, Beverly Hills, CA (US)

(72) Inventors: Farzad Nosrati, Beverly Hills, CA (US); Bahram Shamsian, Los Angeles, CA (US)

(73) Assignee: Eagle Eyes Vision, LLC, Beverly Hills, CA (US)

(21) Appl. No.: 17/338,703

(22) Filed: Jun. 4, 2021

Related U.S. Application Data
(60) Provisional application No. 62/705,255, filed on Jun. 18, 2020.

(51) Int. Cl. H04N 21/472; H04N 7/173; G06Q 10/06; H04N 21/2187

(52) U.S. Cl. CPC H04N 21/47202; H04N 21/2187; G06Q 10/06314; H04N 7/17318

(57) ABSTRACT

The present invention discloses a novel, on-demand, user-controllable, person-to-location audio-visual (A/V) capture and transmit platform and system (the “Eagle Eyes Network” or “EEN”). The network is architected as a “gig economy” platform that enables any Requester who subscribes to the network to, using an app, request a live A/V feed of any location, and for that request to be automatically delivered in real or delayed time to at least one qualified geo-located person or entity in the network—a “Provider.” The EEN also enables the Requester via the app to control aspects of the Provider's A/V live capture session at the location.

### RELATED APPLICATIONS

The application claims the benefit of U.S. Provisional Application No. 62/705,255 filed on Jun. 18, 2020.

### TECHNICAL FIELD

The present invention relates generally to the field of audio-visual (A/V) broadcast systems and in particular to systems and methods for accessing and controlling the on-demand, real-time streaming and recording of locations remote from a requesting user.

### BACKGROUND

Systems and methods for accessing live content via broadcast and internet technologies are well-known. In the modern era, high-bandwidth, live A/V content made available on IP-based platforms such as Facebook™ Live and many others is readily accessible to anyone with a modern mobile device or computer. In these environments, the “broadcaster” simply sets up a “live feed” on the platform, and anyone with access to the platform can log in and watch and hear the feed. Moreover, the technological and cost barriers to making two-way, remote and portable A/V communications widely available to the public have been overcome with the low cost, high availability of high bandwidth cellular and WiFi networks and reliable, low-cost, IP-based A/V platforms such as Apple FaceTime™, Zoom™, Skype™, Microsoft Teams™ and many others.

These conventional remote, interactive, A/V solutions are limited, however, in a number of respects. For one, most are designed for person(s)-to-person(s) communications. That is, an organizer or presenter initiates an A/V communications session with one or more other identified persons, either by contacting the person or persons for an impromptu, “on-demand” session (as is usually the case with a FaceTime or Facebook Portal session) or by sending a message to invitees for a scheduled A/V session for some set time. By contrast, A/V platforms that are not designed primarily for person-to-person communications, but rather are for person-to-location “communications” are typically and primarily for one-way monitoring or recording, such as “always-on” cam viewers, like vehicle and body cams, or stationary devices such as home security cameras, like the Ring™ system, where the person remote from the location can view the field of vision of the camera either live or at a later time from a recording the view.

Unfortunately, none of these A/V platforms can provide on demand access to a live A/V feed of a (any) location of interest and control of that feed to a person or entity remote from the location (the “Requester”).

Accordingly, what is needed is an on-demand A/V platform that enables a Requester to request and secure in real time a live A/V feed of virtually any location of interest, and to remotely gain access and control of a full A/V experience at the location.

What is also needed is such an A/V platform that provides the remote Requester some level of control of over the A/V capture experience.

### SUMMARY

The present invention meets these needs by disclosing a novel remote, on-demand, user-controllable, person-to-location A/V capture platform and system (the “Eagle Eyes Network” or “EEN”) that solves the aforementioned problems and more. In preferred embodiments, the EEN is architected as a “gig economy” platform that enables any Requester who subscribes to the network to, using an app, request a live audio/visual feed of any location, and for that request to be automatically delivered in real time to at least one qualified geo-located person or entity in the network—a “Provider”—that may meet certain additional selection criteria. When the selected Provider accepts the request, the Provider ensures that the Provider capture equipment arrives at the requested location to capture and transmit the requested A/V feed to the Requester via the EEN.

In some embodiments, the EEN also enables the scheduling of A/V sessions at Target Locations at future times. The inventive system described here also discloses a novel companion communications application (“Eagle Eyes Requester App” or EERA), that may be downloadable to a Requester computer or a mobile device or both (“Remote Requester Device” or RRD), in communications with the network (“the Eagle Eyes™ Network” or “EEN”). This creates an environment whereby a Requester wishing to gain access to a customizable live and/or scheduled visual and/or audio broadcast of a specific location remote from the Requester, may transmit the request and required parameters to the EEN who will in turn identify and select a person or entity (“Provider”) equipped with a networked A/V capture device (“Provider Capture Device”), such as a dedicated networked camera or a mobile device with a built-in camera, who can then accept “the job” and broadcast the requested A/V data back to the Requester though the EEN. This EERA may also enable a Requester to gain access to customized broadcast of data that is otherwise unavailable within the existing environment of the Requester. The app may further enable a Requester to access the services of a Provider for a fee.

In other embodiments, a process using a digital audio-visual (A/V) content management system for on-demand, location-based capture and transmission of A/V content to a requester device associated with a requester that is subscribed to the system is discloses. This process preferably includes the steps of (a) receiving a request from the requester device for A/V content to be captured at a location specified by the requester; (b) identifying, among a plurality of subscribed providers equipped with A/V capture devices that are networked to the system, a first provider that is suitable to perform the capture at the location, based at least in part on the location of the first provider relative to the location specified by the request; (c) offering the first provider to perform the capture at the selected location; and upon the first provider acceptance of the offer, receiving from the provider capture device an audio-visual feed from the requested location. Then, the system may then send the feed to the requester. In some embodiments, the feed is a live audio-visual feed and the sending to the requester is done in real time. In other embodiments, an additional step includes storing the feed in a server of the content management system, which may then be sent to the requester or others at a later time, such as at a scheduled time. In some embodiment, the stored feed may be made available to anyone with access to the system for a fee or for no fee. In some instances, the request from the requester is for A/V content to be captured at a time specified by the requester device.

In yet other embodiments, the step of identifying includes identifying a subset of providers among the plurality of providers that are suitable to perform the capture at the location, the step of offering includes offering the subset of providers to perform the capture, and the first provider is the first provider among the subset to accept the offer. In additional embodiments, the process further includes after the first provider accepts the offer and before the provider capture device captures the content, connecting the receiver device to the provider device.

In some embodiments, the requester device directs the provider during the performance of the capture to manipulate the provider capture device according to instructions provided by the requester.

The process may further include the steps of charging the requester a fee for the sending of the feed and paying the provider a pre-determined amount for the provision of the feed. In some implementations, the amounts charged to the requester and paid to the provider may be at least partially negotiated by the requester and provider.

In alternative embodiments, a networked, A/V content management system is also disclosed by the present invention, wherein the system includes at least one processor and a non-transitory computer-readable medium encoded with computer readable instructions. This management system enables the transmission of captured A/V content from at least one subscribed provider to at least one subscribed requester, wherein execution of said computer-readable instructions is configured to cause at least one central processor to execute steps comprising obtaining subscribed requester information from computing devices of plural subscribed requesters; obtaining subscribed provider information from computing devices of plural subscribed providers obtaining from a computing device of at least one of the plural subscribed requesters a request for the capture and transmission of A/V content at a location of interest to the at least one plural subscribed requester; selecting one of the plural subscribed providers having an A/V capture device in the vicinity of the location of interest as a candidate to fulfill the request; transmitting the request to the selected provider; and receiving, via the network, from the A/V capture device of the selected provider who accepted the request packetized A/V content captured by the device at the location of interest. In embodiments, the execution of the computer-readable instructions is configured to cause at least one central processor to further execute the step of transmitting the captured packetized A/V content to a networked device of the requester.

In yet other embodiments, computer-implemented methods for operating one or more servers to provide a service for arranging the provision of A/V captured content of and at a location of interest to a requester are disclosed. One method may comprise the steps of (a) detecting a customer application executing on a computing device of a requester, the requester application automatically communicating with the service over a network; (b) receiving from the computing device of the requester, a request for the capture of the A/V content at a requester-specified location and time; (c) determining a current location of a plurality of available providers subscribed to the service. In this embodiment, the current location of each available provider in the plurality of available providers may be based on data determined by a corresponding provider application executing on a corresponding mobile computing device associated with that provider, wherein on each available provider device in the plurality, the corresponding provider application executes to access a GPS resource of the corresponding mobile computing device in order to provide the data for determining the current location of that available provider to the service. The method may further include (d) communicating with the requester application executing on the computing device of the requester to receive the A/V captured content. This communication step may preferably include: (i) providing data to the customer application executing on the mobile computing device to generate a presentation on a display of the mobile computing device of the customer, the presentation including a list of A/V capture options while concurrently providing a user interface feature from which the requester can trigger transmission of a request to initiate, by the one or more servers, a selection process to offer or assign the capture request to one of the plurality of providers; (ii) determining, from the plurality of available providers, one or more providers that satisfy criteria including at least of being within a designated proximity to the requested capture location; and (iii) providing data to the requester application executing on the mobile computing device to cause the presentation to depict the current location of the one or more providers that satisfy the criteria and a predicted response time for the one or more providers that satisfies the criteria to arrive at the requested location. The method then may further preferably includes the steps of (e) in response to receiving the triggered transmission of the request from the user interface feature, initiating the selection process by programmatically selecting an available provider from the one or more providers to be assigned to execute an A/V content capture session, and then determining information to communicate to the provider application executing on the mobile computing device associated with the selected provider, the determined information including the location for the capture session; and (f) upon the provider arriving at the requested capture location, enabling the requester device application to communicate with the provider and provide A/V capture instruction.

In other embodiments, this method further includes the step of determining a fee for providing the A/V content to the requester, wherein the fee is based at least in part on the capture location. The method may also further include the step of enabling the requester to view a live stream of the location from the provider's A/V capture computing device during the A/V content capture session. The method may also enable the requester device to remotely control the A/V content capture session being captured by the provider device.

It is to be understood that the invention is not limited in its application to the details of construction and the arrangement of components described hereinafter and illustrated in the drawings and photographs. Those skilled in the art will recognize that various modifications can be made without departing from the scope of the invention.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is an illustrative high level network diagram showing entities involved in and components used in one non-limiting embodiment of the present invention;

FIG. 2 is a block diagram of the network computer system shown in FIG. 1;

FIG. 3 is a block flow diagram showing the steps processed by the EENS platform to request an A/V session in accordance with one non-limiting embodiment of the present invention;

FIG. 4 is a block flow diagram showing the steps implemented by the EENS platform in accepting an A/V request session in accordance with one non-limiting embodiment of the present invention;

FIGS. 5a-5c is a block flow diagram showing the steps implemented by the EENS platform in fulfilling an A/V request session in accordance with one non-limiting embodiment of the present invention;

FIG. 6 is a block flow diagram showing the steps implemented by the EENS platform when a provider job fails in accordance with one non-limiting embodiment of the present invention; and

FIG. 7 is a block flow diagram showing the steps implemented by the EENS platform in a Provider selection process in accordance with one non-limiting embodiment of the present invention.

### DETAILED DESCRIPTION OF THE PREFERRED EMBODIMENTS

Referring now to the drawings, like reference numerals designate identical or corresponding features throughout the several views.

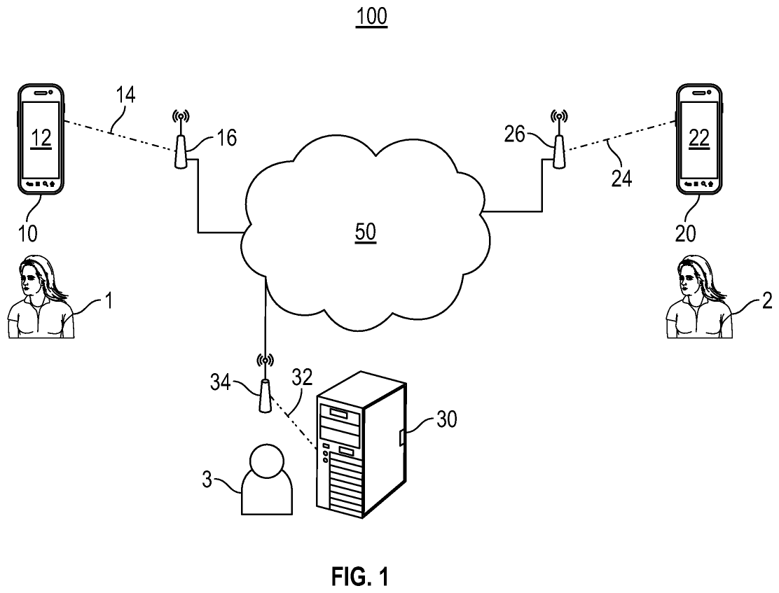

The drawings show a number of structural and flow diagrams that explain preferred processes and components of the present invention. FIG. 1 is a diagram showing a high-level schematic view of one optional illustrative on-demand virtual A/V broadcast system 100, also call by the inventors the Eagle Eyes Network™ (or “EEN”) along with users of the network, in accordance with embodiments of the present invention. It should be understood that data may be transferred to any parts of the system, stored by the system or devices and/or transferred by the system to users of the system across any kind of wired, wireless or mixed network, such as local area networks (LANs) or wide area networks (WANs). In accordance with various embodiments, the system may be comprised of numerous servers, data mining hardware, artificial intelligence programs, computing devices, or any combinations thereof, communicatively connected across one or more networks, such as LANs and/or WANs. One of ordinary skill in the art would appreciate that there are numerous manners in which the system could be configured, and embodiments of the present disclosure are contemplated for use with any operable configuration. Thus, in the depicted embodiment of FIG. 1, in which a simplified schematic overview shows entities (or users) present and components of the on-demand virtual A/V system 100 of the Eagle Eyes Network of the present invention communicating in a wireless environment, it is understood that the invention is not be limited as such. Requester 1 employs on-demand, A/V system, or EEN 100 to access a provider, Provider 2 (who has signed up with and been approved by an EEN administrator), equipped with a Provider A/V capture device PCD 20 who is in the vicinity of a location of interest to Requester 1 (“Target Location”), and to instruct Provider 2 and/or her device 20 to capture the A/V environment at the specific location of interest and time for transmittal to Requester 1.

In this embodiment, EEN 100 anticipates Requester 1 being equipped with a networked computing device, referred to as Remote Requester Device (RRD) 10, here embodied as a wireless mobile smartphone, having wirelessly downloaded to it an Eagle Eyes Requester App (EERA) 12 from an app server, such as Google Play or Apple's App Store, or from a dedicated Eagle Eyes App Server (EEAS). EERA 12 enables Requester 1 to initiate, request and manage an A/V session at a Target Location selected by Requester 1. Likewise, Provider 2, also equipped with her own networked computing device, referred to as Provider Capture Device 20, also shown in FIG. 1 as a wireless mobile device, has wirelessly downloaded Eagle Eyes Provider App (EEPA) 22 from an app server/store. Thus, with EERA 12 launched on RRD 10 (that in this embodiment is not on a WiFi network), Requester 1 may send a data request 14 via cellular network 16 through wide area network cloud 50, such as the Internet, to Eagle Eyes Network Server, or EENS, 30 (that may be administered by entity 3) to initiate an on-demand A/V session at a location of interest identified by Requester 1 in her request. In some embodiments, EENS 30 employs or accesses a location-based network, such as a GPS or other similar network, that keeps track of the location of all active Providers on its network. In this way, EENS 30 can identify all active Providers, as well as those in the vicinity of (e.g, a preset or selectable maximum distance from) the precise location of interest selected by Requester 1.

In this exemplary embodiment shown of FIG. 1, using a Provider Candidate Algorithm (PCA) (not shown), EENS 30 has determined that Provider 2's PCD 20 running EEPA 22 is a candidate to handle Requester 1's request. For example, PCA may have identified Provider 2 as the closest active provider to the location of interest selected by Requester 1. EENS 30 thus preferably automatically and in real time sends a request to Provider 2's PCD 20/EEPA 22 inviting Provider 2 accept Requester 1's request for an A/V capture or “capture and transmit” session. It should be understood that in certain embodiments, the apps downloaded to Requester and Provider devices 10, 20 respectively, EERA 12 and EEPA 22, may be designed as a single app, with features enabling a user to act as a Requester, a Provider, or both.

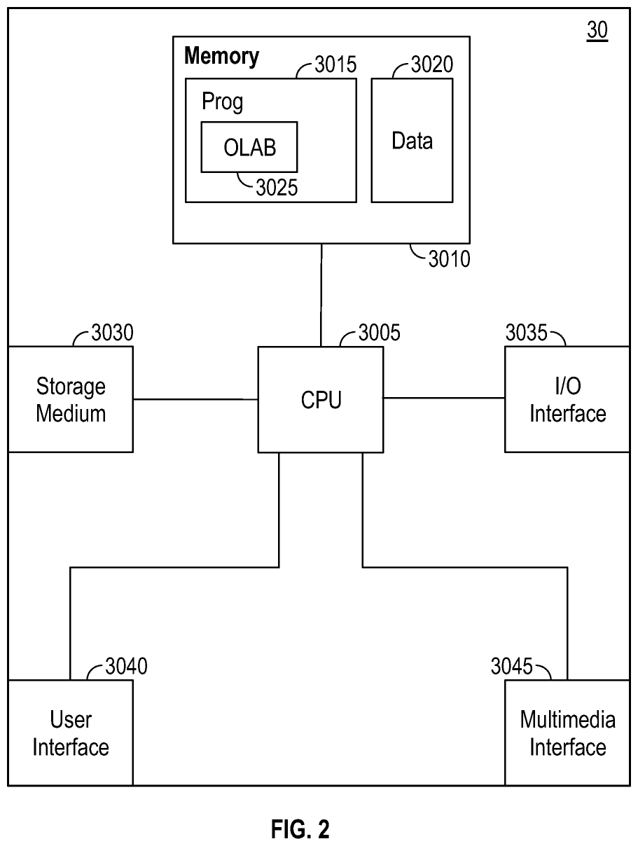

In the exemplary depicted embodiment, EEN Server 30 comprises an on-demand, location-based, A/V Broadcast (“OLAB”) System Server configured to enable users (Requesters and Providers) of the System to (a) request location-based data feeds comprising A/V sessions and to select and hire qualified Providers to provide such data, and in some embodiments, review Providers (Requesters); and (b) provide the requested data feeds (Providers) to Requesters. Thus, FIG. 2 is a block diagram showing a structural view of an exemplary Eagle Eyes Location-based On-Demand, A/V Broadcast System Server system 30 as shown in FIG. 1, configured in accordance with various embodiments of the present invention. FIG. 2 includes Processor 3005 in communicatively and operably connected with Memory 3010. Memory 3010 preferably includes program memory 3015 and data memory 3020. Depicted program memory 3015 includes processor-executable program instructions implementing OLAB (On-Demand, Location-Based Audio-Visual Broadcast) Engine 3025. In various implementations, the depicted data memory 3020 may include data configured to encode a predictive analytic model. In some embodiments, the illustrated program memory 3015 may include processor-executable program instructions configured to implement an OS (Operating System). In various embodiments, the OS may include processor executable program instructions configured to implement various operations when executed by the processor 3005. In some embodiments, the OS may be omitted. In some embodiments, the illustrated program memory 3015 may include processor-executable program instructions configured to implement various Application Software. In various embodiments, the Application Software may include processor executable program instructions configured to implement various operations when executed by the processor 3005. In some embodiments, the Application Software may be omitted. In various embodiments, the illustrated program memory 3015 may include one or more API's which when executed can call third party systems, such as location-based service providers that provide, using GPS or other known location-based technologies, precise or near precise location of Provider Devices 20 belonging to Providers 2 subscribed to the EEN 100.

In the depicted embodiment, processor 3005 is communicatively and operably coupled with the storage medium 3030. In the depicted embodiment, the processor 3005 is communicatively and operably coupled with the 1/O (Input/Output) interface 3035. In the depicted embodiment, the 1/O interface 3035 includes a network interface. In various implementations, the network interface may be a wireless network interface. In some designs, the network interface may be a Wi-Fi interface. In some embodiments, the network interface may be a Bluetooth interface. In an illustrative example, the Eagle Eyes Location-based On-Demand, A/V Broadcast System Server 30 may include more than one network interface. In some designs, the network interface may be a wireline interface. In some designs, the network interface may be omitted. In the depicted embodiment, the processor 3005 is communicatively and operably coupled with the user interface 3040. In various implementations, the user interface 3040 may be adapted to receive input from a user or send output to a user. In some embodiments, the user interface 3040 may be adapted to an input-only or output-only user interface mode. In various implementations, the user interface 3040 may include an imaging display. In some embodiments, the user interface 3040 may include an audio interface. In some designs, the audio interface may include an audio input. In various designs, the audio interface may include an audio output. In some implementations, the user interface 3040 may be touch-sensitive. In some designs, the Eagle Eyes Location-based On-Demand, A/V Broadcast System Server 30 may include an accelerometer operably coupled with the processor 3005. In various embodiments, the Eagle Eyes Location-based On-Demand, A/V Broadcast system 30 may itself include a GPS module or other location-based module operably coupled with the processor 3005. In an illustrative example, the Eagle Eyes Location-based On-Demand, A/V Broadcast System Server platform 30 may include a magnetometer operably coupled with the processor 3005. In some embodiments, some or all parts of an Eagle Eyes Location-based On-Demand, A/V Broadcast System Server 30 may be included within a client device, such that it may include image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In various implementations, the depicted memory 3010 may contain processor executable program instruction modules configurable by the processor 3005 to be adapted to provide image input capability, image or video output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In some embodiments, the input sensor array may include audio sensing subsystems or modules configurable by the processor 3005 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In various implementations, the depicted memory 3010 may contain processor executable program instruction modules configurable by the processor 3005 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection.

In the depicted embodiment, the processor 3005 is communicatively and operably coupled with the multimedia interface 3045. In the illustrated embodiment, the multimedia interface 3045 includes interfaces adapted to input and output of audio, video, and image data. In some preferred embodiments, the data may be inputted to system 30 via interface 3045 as live streamed A/V data from Provider devices 20, and in other cases it may be transmitted to system 30 in bulk at set times. In live feed embodiments, multimedia interface 3045 may be used to immediately output received data streams from Provider devices 20 to the requesting Requester devices 10.

In some embodiments, the multimedia interface 3045 may include one or more still image camera or video camera. In various designs, the multimedia interface 3045 may include one or more microphone. In some implementations, the multimedia interface 3045 may include a wireless communication means configured to operably and communicatively couple the multimedia interface 3045 with a multimedia data source or sink external to the Eagle Eyes Location-based On-Demand, A/V Broadcast system 30. In various designs, the multimedia interface 3045 may include interfaces adapted to send, receive, or process encoded audio or video. In various embodiments, the multimedia interface 3045 may include one or more video, image, or audio encoder. In various designs, the multimedia interface 3045 may include one or more video, image, or audio decoder. In various implementations, the multimedia interface 3045 may include interfaces adapted to send, receive, or process one or more multimedia stream. In various implementations, the multimedia interface 3045 may include a GPU.

Useful examples of the illustrated Eagle Eyes On-Demand, Location-Based, A/V Broadcast (OLAB) system 30 include, but are not limited to, personal computers, servers, tablet PCs, smartphones, or other computing devices. In some embodiments, multiple Eagle Eyes Location-based On-Demand, A/V Broadcast system 30 devices may be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art.

Thus, in the depicted embodiment in FIG. 1, the Eagle Eyes Location-based On-Demand, A/V Broadcast system 30 is an exemplary platform. In the illustrated example, the Requester 1 and Provider 2 employ their exemplary mobile computing device 10, 20 respectively, to use the exemplary Eagle Eyes On-Demand Location-Based, A/V Broadcast OLAB Platform 30 via the network cloud 50.

As seen, a “Requester” 10 is any individual or entity equipped with a “Remote Requester Device” who or which is in need of customized, broadcasted A/V content at a specific location or locations of interest. A “Provider is an individual, organization or technology (such as a robot) equipped with a “Mobile Provider Device” who is contacted by a Requester to provide the requested, specialized live or recorded A/V broadcast.

The system 100, when initiated by EERA 12 described herein, thus provides a remote connection between Requestor 1 and Provider 2 over “Eagle Eyes Network”, EEN, to enable the transfer and storage of the video and audio transmitted data though this network application.

In some embodiments, Requester 1 may enter into the EERA both a target location and target time of broadcast. In others, a “broadcast type” and broadcast quality of recording may be selected via the EERA. In yet other embodiments, a set or negotiated fee may be used to select these and other features. This, a request for an A/V session may be initiated for an immediate “on-demand” live broadcast, or for a live broadcast at a future time or a recorded broadcast at a present or future time.

In further detail, a menu presented to Requester in the EERA may allow the Requester to enter additional instructions in order to customize the request and transmit this instruction to the Provider 2. Provider 2 may receive such requests through it EEPA via the network and accept, reject and/or negotiate with the Requester to provide the requested data for an agreed contracted fee.

In yet further embodiments, the requested data or media may comprise video, audio, still photos from a PCD as mobile device 20. A PCD may also comprise more than one physical device for multi-view data streaming. For example, a PCD may include an aerial drone surveillance camera and a stationery or mobile security camera for multiple feeds. Such embodiments may be useful for home, estate or building security systems, public traffic and monitoring systems, or any other environment that may benefit from on demand broadcast enabled A/V streams.

Requester 1 and Provider 2 may establish direct 2-way communication with each other via their respective apps 12, 22 using a networked communication channel between the Requester and Provider. In such case, for example, Requester can send special instructions through a keyboard entry. Likewise, Provider may inform Requester of certain conditions, obstacles or suggestions via voice or text. This communication channel between Requester and Provider can enable customizable viewing and recording with Requester sending such parameters during a live broadcast.

It should be understood that the requested A/V data maybe located in any location, local or distant to Requester, anywhere in the world, whether public or private, governmental or educational or conventional or medical, indoors or outdoors, exterior or elevated, underwater or underground, aerial or outer space, or any other location attainable by a A/V capture equipment.

In some embodiments, Requester 1 may be charged a negotiated fee for the requested data. Provider 2 may receive a fee for the said transmitted data once it is satisfactorily completed, and the Eagle Eyes administrator 3 may receive a commission-based fee for enabling and managing said transaction.

Thus, in preferred embodiments, the captured A/V data is securely transmitted from Provider Device 20 (in FIG. 1) to Requester's RD 10 in the EEN 100. This data may be stored by EEN on a local or cloud-based data storage system and can be made available to Requester 1 immediately or on a negotiated fee-based arrangement for a negotiated time period. In preferred embodiments, EENS 30 keeps track of all Requester requests for A/V data. This would include all requested and pending requests, those requests filled by a Provider but not transmitted and those unfulfilled requests. In some use cases, the A/V data may be denoted or tagged by Requester, or others, as either private or public. If designated public, one option would be to allow stored A/V data to become available to other users, participants and outside parties for a negotiated fee, along with a negotiated commission for the Requester and/or Provider.

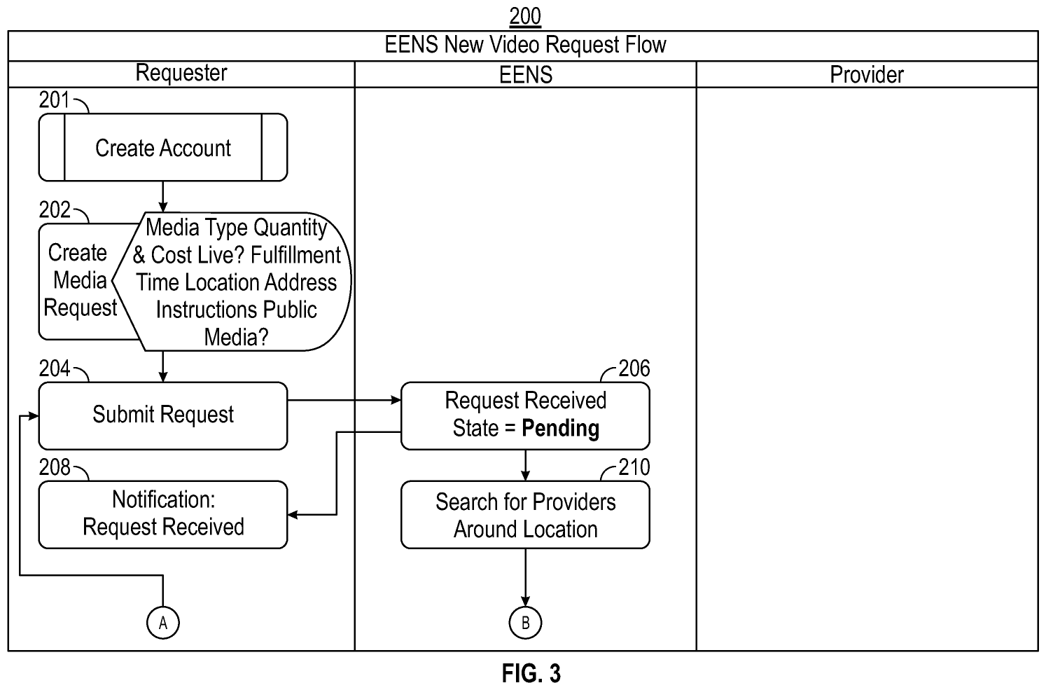

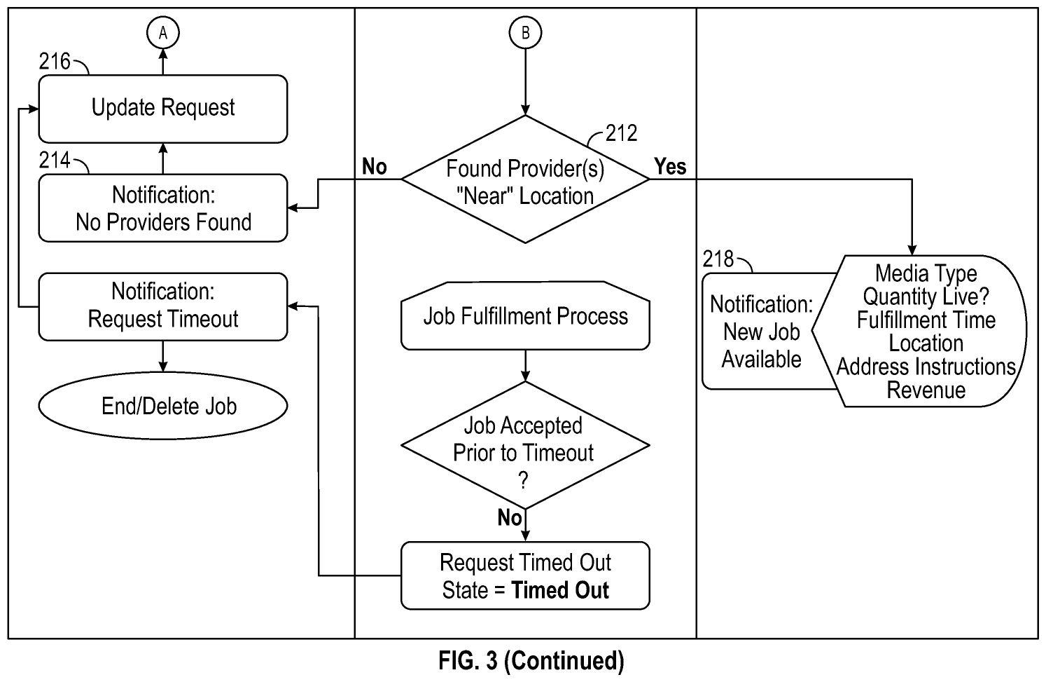

Data flows among a Requester 1 (left column), the EENS 30 (middle column) and one or more Providers 2 (right column) for executing various processes implemented in embodiments of the present are now described in connection with FIGS. 3-7. Thus, FIG. 3 is a simplified block flow diagram 200 showing preferred steps processed by EENS 100 platform for a Requester request for a new A/V capture session in accordance with one non-limiting embodiment of the present invention. Continuing with the exemplary embodiment shown in FIG. 1, the process starts at step 201 with Requester 1 creating a new user account with the EENS platform, thus becoming a subscriber to the platform. As is well understood, subscribing can be accomplished in any number of manners including via App 12, online at a website, on a phone call, in paper, or any other means. Now, at step 202, Requester decides to and creates (for example in FIG. 1 using app 12, or on a desktop app, not shown) a new media request. As seen, this request can include a number of parameters including media type, quantity or length of a capture session, live feed or not, fulfillment time, the Target Location's specific address to geographic coordinates, special instructions, and whether to make the livestream and/or recording public or private. Many other or additional options are possible and within the scope of the invention.

Once all options are selected by the Requester, at step 204, she submits the request, which is received by the EENS system 30 at step 206. At this point, the system designates the request as “Pending.” The system sends and Requester receives in step 208 a Notification that the request was received. In this simplified embodiment, this triggers system 30 in step 210 to search for and in step 212 find potential Providers that are located in the vicinity of the Target Location, using any suitable geo-locating technology. If no potential Provider is found, Requester in step 214 receives from EENS 30 a notification stating “No Providers Found.” If a Provider is found, then the candidate Provider receives in step 218 a notification stating “New Job Available.” The notice may also include one or more of the hiring criteria selected by Requester in addition to a fee the Provider may make for fulfilling the request.

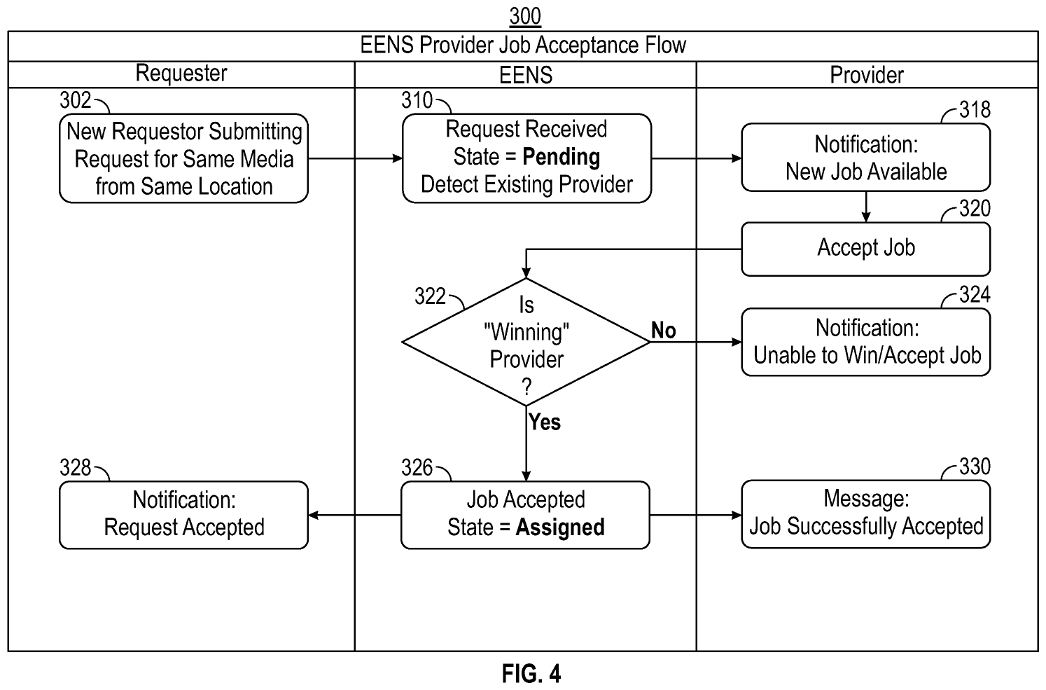

FIG. 4 now shows the data flow 300 of one embodiment for a selected Provider's acceptance of a job request. As seen, when Requester 1 submits a request for a job in step 302 and EENS 30 receives the request, and in step 310 sets the state to “Request Pending” and detects a potential provider, as discussed in the prior figure, the potential provider receives at step 318 a “New Job Available” notice. If the provider accepts at step 320, the system at step 322 queries whether this provider is the “winner” of the job, since the possibility exists that another potential provider that met Requester's criteria already accepted. If the potential provider's acceptance is accepted, then at step 326 the system designates the job as “Accepted”, changing the job state to “Assigned, and sends notices to both the Requester and Provider of the acceptance, received by each at steps 328 and 330, respectively.

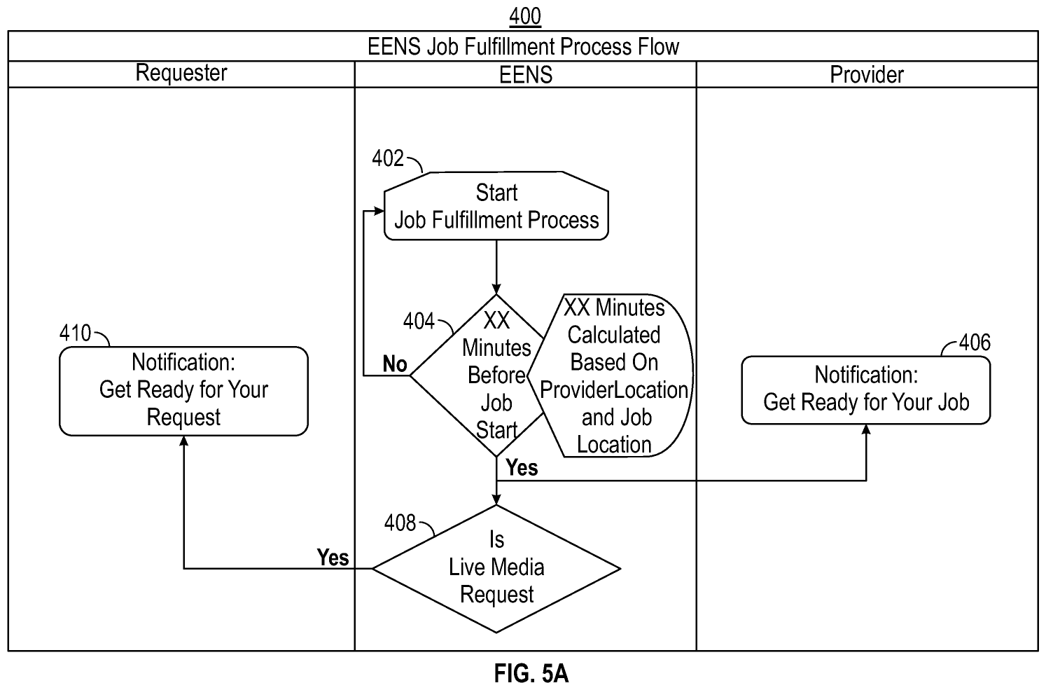

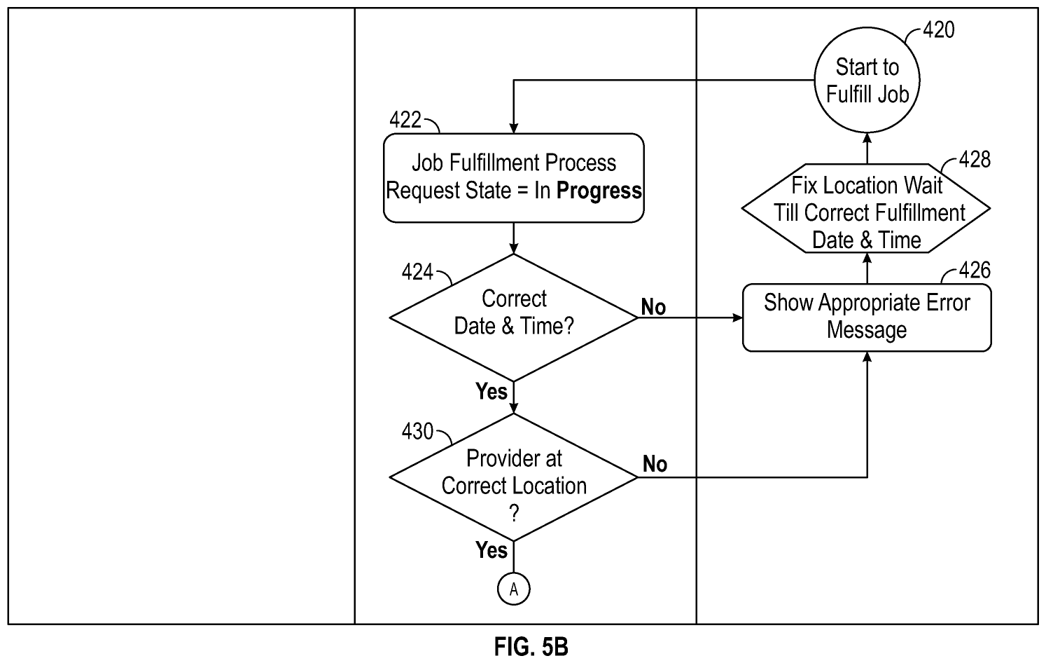

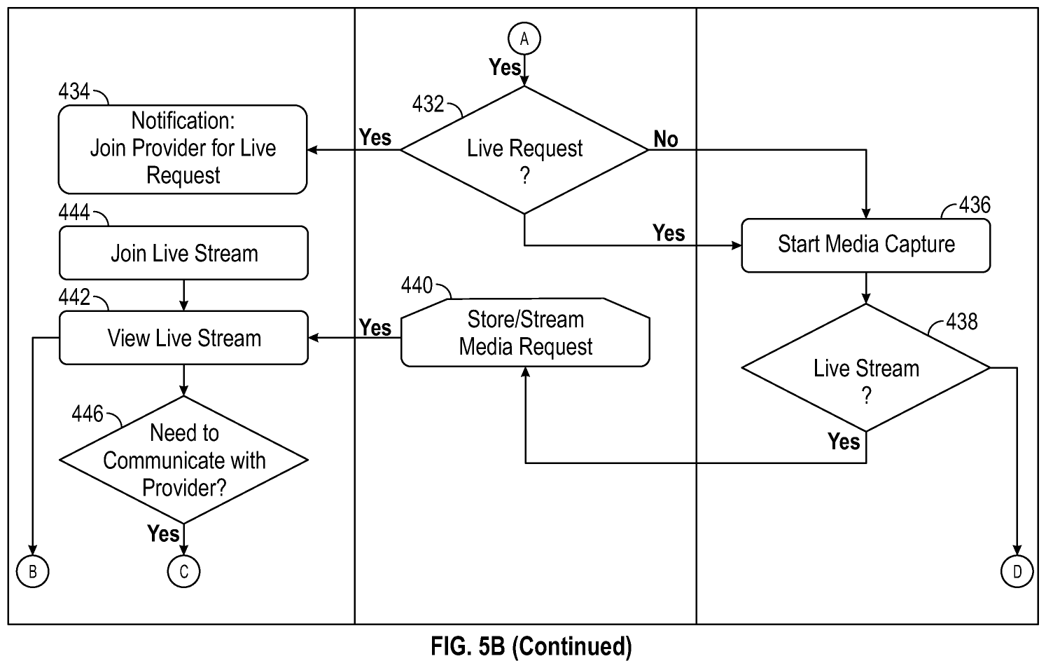

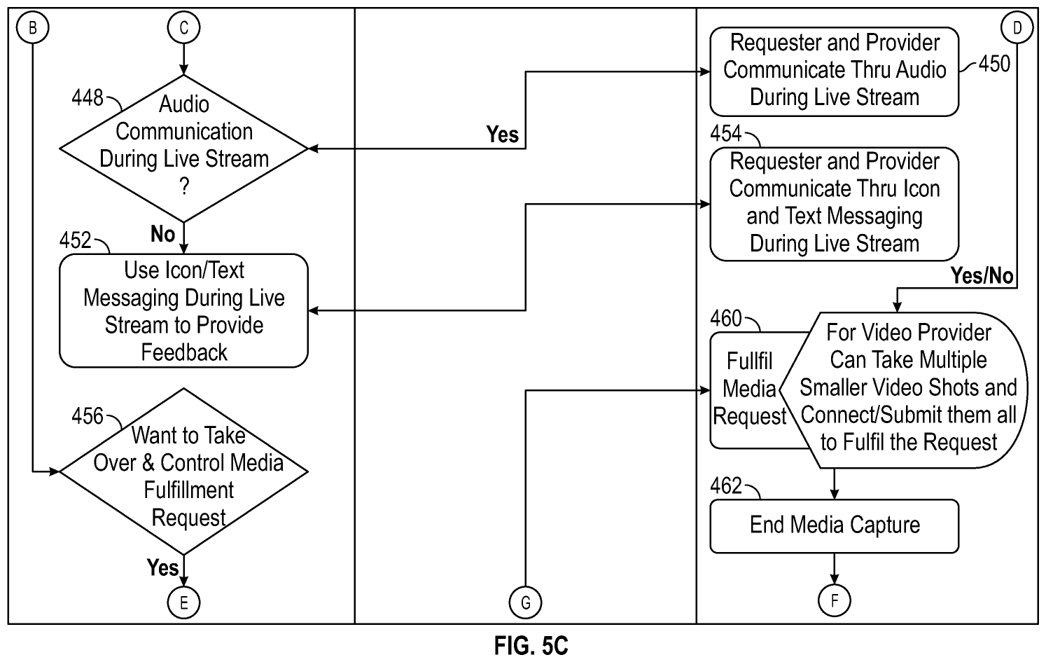

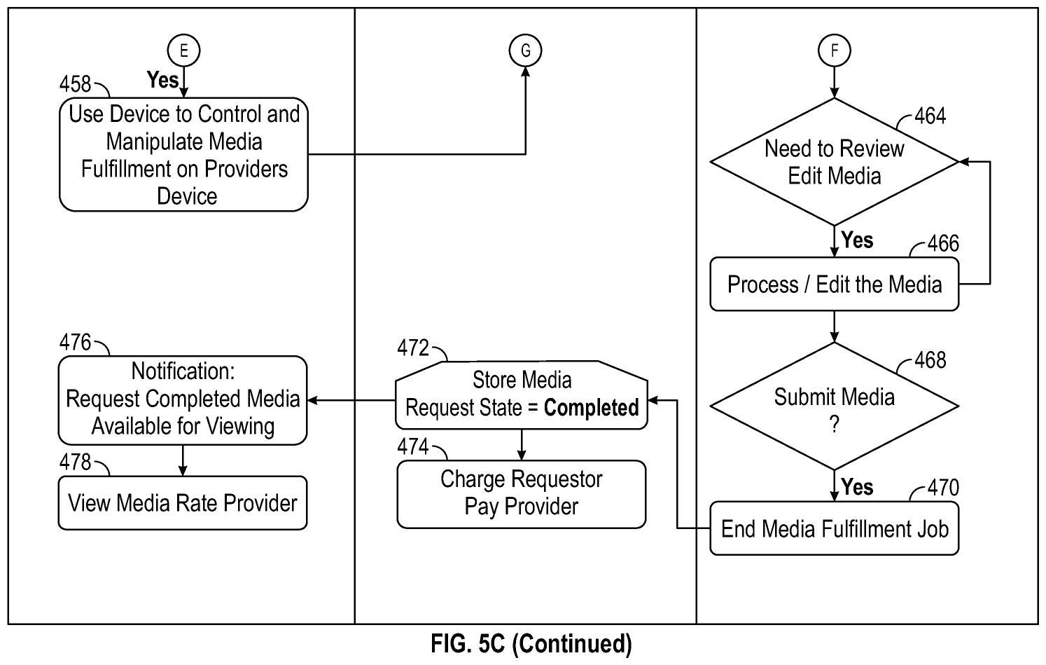

Now, that the entities are paired, the work begins to fulfill the job request. Thus, FIGS. 5a-5b show a block flow diagram 400 showing the steps implemented by the EENS platform in fulfilling an A/V request session in accordance with one non-limiting embodiment of the present invention. The fulfillment process starts in the system 30 at step 402 which triggers at step 404 a system timer to be set by which the selected Provider should fulfill the request. If the timing in the request is to capture A/V content at the Target Location As Soon As Possible (ASAP), the system may base the timer off of the calculated estimated number of minutes it should take the Provider wherever she is currently located, as known by the system based on her tracked geo-location, to arrive at the Target Location, whether by car, on foot, or other means of moving (as pre-indicated by provider in the system). The system then send a notice, received in step 406 by Provider at her computing device 20, to get ready for the job, preferably along with a timer indicating for how long the job will stay open and exclusive to her. Moreover, if the job selected is to be a live, streaming event (aka, “livestreamed”), Requester at step 410 will also receive a notice from system 30 to “get ready” for the request to be fulfilled—namely, to have their device at hand ready to view and listen to the livestream.

After receiving the “get ready” notice in step 406, the Provider at step 420 accordingly is expected to get ready to fulfill the job request. This typically means that she/he would travel to the specific Target Location at the correct date and time—and if an ASAP request, by the calculated time the system anticipates it would take to get from the place of acceptance to the Target Location (plus potentially some safety margin). In Step 422, the EENS then sets a “Job Fulfillment Process Request State” equal to “In Progress” and checks to ensure at step 424 that the Provider is doing the job at the correct date and time, and, if yes, at step 430 is at the Target Location. If either at step 424, the system determines the Provider has started to fulfill the job at the wrong date or time, or at step 430 the system determines that the Provider is not at the correct Target location, then at step 426, the Provider will receive on her/his app an appropriate error message, and at step 428, will place the Provider in a holding pattern to have her wait until the correct date/time or until she arrives at the Target Location, as the case may be.

Assuming the Provider is at the correct place and the requested time, the system queries at step 432 whether the A/V session request is a “Live Request.” If it is, at step 434 the Requester receives a notification to her EENS app enabling Requester to request from the app to join the Provider in a live, video conference-type session during the A/V session. Whether or not it is “Live Request”, at step 436, Provider starts her Provider Capture Device (PCD) to begin capturing the A/V content at the target location. It should be understood that the target location can be any place a PCD can capture an image and sound. Thus, it may be a field, the outside of a structure, such as an office building, shopping center or a home, or the inside of same.

At the same time, if the request is for a “live stream” of the A/V content, at step 438, the Provider will live stream the A/V feed being captured. In this instance, the A/V content is streamed over the network first, at step 440 to the EENS 30, which in turn streams it to the Requester device at step 442. At this point, at step 444, the requester may join and view/listen to the live stream. Note that even though the request at step 438 is for a live stream, the EENS 30 will preferably store the streaming A/V content in storage medium 3030 for later use. Moreover, the A/C content may be further processed by processor 3005 (FIG. 2) in myriad conventional ways for many use cases.

At this point, a number of additional novel aspects and options of the present invention are shown in the continuing process flow shown in FIGS. 5c and 5d. In particular, during the live feed of the A/V session provided to Requester on her A/V Computing Device (RCD) 10, the Requester is presented in her App 12 with several options. First, at step 446, during the Requester with the option to communicate directly with Provider, typically to give live instructions to the Provider concerning the live stream event, if this option is selected, then Requester 2 is offered first at step 448 to establish an audio connection with the Provider, so Requester at step 450 can speak with Provider. If the Audio option is not selected, then at step 452 the Requester is offered to provide feedback to Provider by communicating with her at step 454 using either descriptive Icons presented by the App 12 or with text messaging.

In addition to the communications options, the Requester on App 12 is also presented with yet another inventive option, at step 456, namely, the option enabling Requester to take over full media control of the live feed from Provider's device 20. If that option is requested, then at step 458, Requesters device 10 is enabled with a menu of options to control and manipulate the fulfillment of the media request on Providers PCD 20 (more on this below).

Whether the media capture fulfillment on PCD 20 is provided by the Provider 2 herself, or remotely by Requester 1, or a combination of the two, at step 460, the Media request is fulfilled/completed, typically for the time requested. Completing the job may be as simple as streaming a straight up A/V videotaping of the location or scene for a set amount of time, or, it may take different forms. For example, as seen in the note next to step 460, the video streamed may comprise multiple smaller video captures or camera shots and may stream them all in a stop/start fashion. At this point, in step 462 the media capture/stream is stopped.

In some instances, in step 464, the Provider will want to or be requested to review the captured media on her device 20. If so, at step 466, Provider will have the option to locally process and/or edit the captured media that was streamed. Whether or not processed or edited, at step 468, Provider is asked to submit the A/V captured content to the network. If submitted at step 470, the job is considered fulfilled and the media is sent over the EEN to the EENS 30 and stored there at step 472, while the job state is designed as “Completed”. At this point, two things happen. EENS 30 at step 474 handles the payments—charging the Requester for the content and paying the Provider for the service—and sends a notice to Requester. At step 476, Requester receives this Notification that the Request has been properly completed and that the media is available for viewing. Finally, optionally, at step 478, Requester may view the media and review or rate the Provider for the quality of the service just provided.

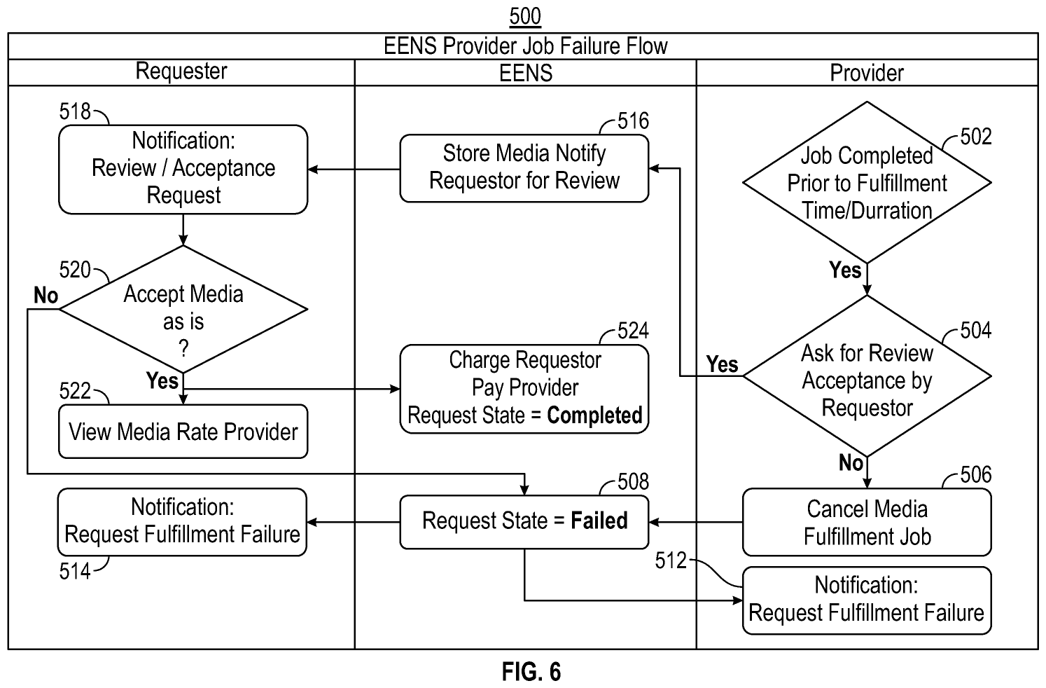

The present invention also provides for the handling of the situation where Provider 2 fails to fulfill or properly fulfill an accepted job request. This scenario is processed by the system with one preferred flow diagram 500 shown in FIG. 6. showing the steps implemented by the EEN platform when a provider job fails in accordance with one non-limiting embodiment of the present invention

In particular, after accepting and commencing a job at a requester targeted location at a requested time, at step 502, the Provider ceases the live stream A/V session before completing the job. Here, the Provider at step 504 is given the option (in her App) to seek a review of the job to be accepted or not by Requester, perhaps because she felt she did a “good enough job.” If Provider does not think it is worth asking Requester to accept the job, at step 506 the Provider then cancels the fulfillment job, and the cancellation is sent to the EENS 30. In this case, in step 508, the Request State is set to “Failed.” In turn, the EENS 30 send a Notice to Requester, received at Step 514 informing her that the Request Fulfillment was a Failure. At the same time, the EENS also sends a notice to Provider, received at Step 512 with the same “Request Fulfillment Failure” message.

However, if in response, to the option in step 504, Provider does choose to ask Requester to review of the incomplete job, then then media captured is sent to the EENS 30, where in step 516 it is stored. At this step, the EENS 30 also send a notification to the Requestor that Provider wishes the incomplete streamed job to be reviewed for potential acceptance. In this case, at step 518, Requester receives this notice to review. Now, Requester, having just watched and listened to the partial livestream, has the option to accept the job or not. At step 520, if Requester decides that the partial job was sufficient for her purposes and selects “Yes, Accept Media As Is”, then at step 522 Requester gets to view or keep a copy of the media (based on whatever pay plan was selected) and rate the Provider, while at step 524 this acceptance having been sent back to EENS 30, the EENS charges Requester and Pays Provider for the job completed, and sets the Request State to “Completed.”

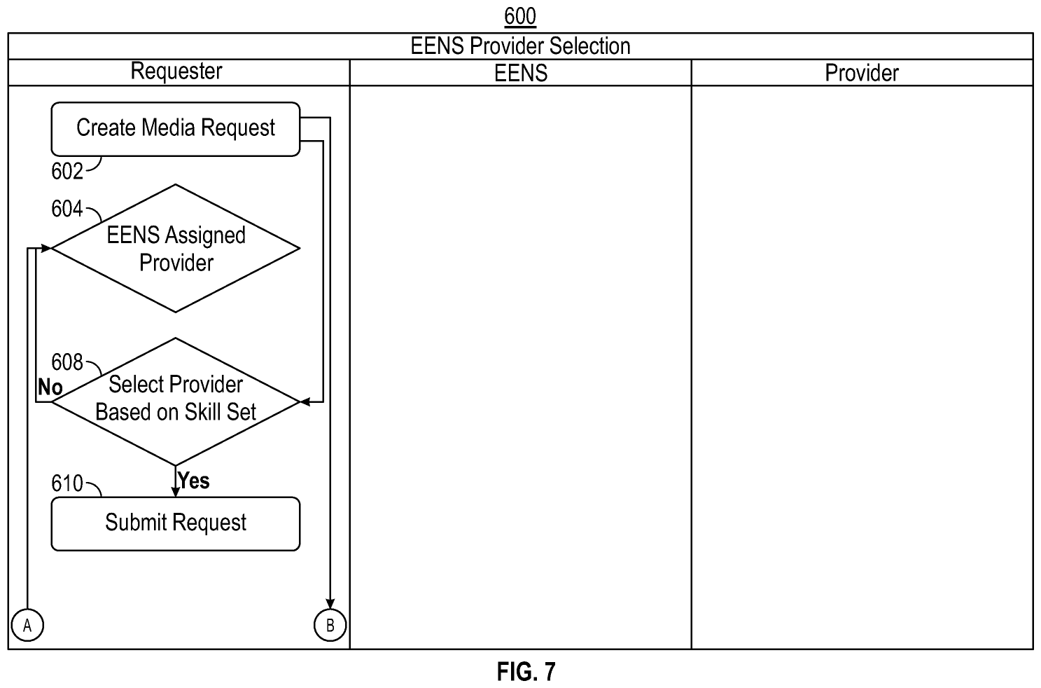

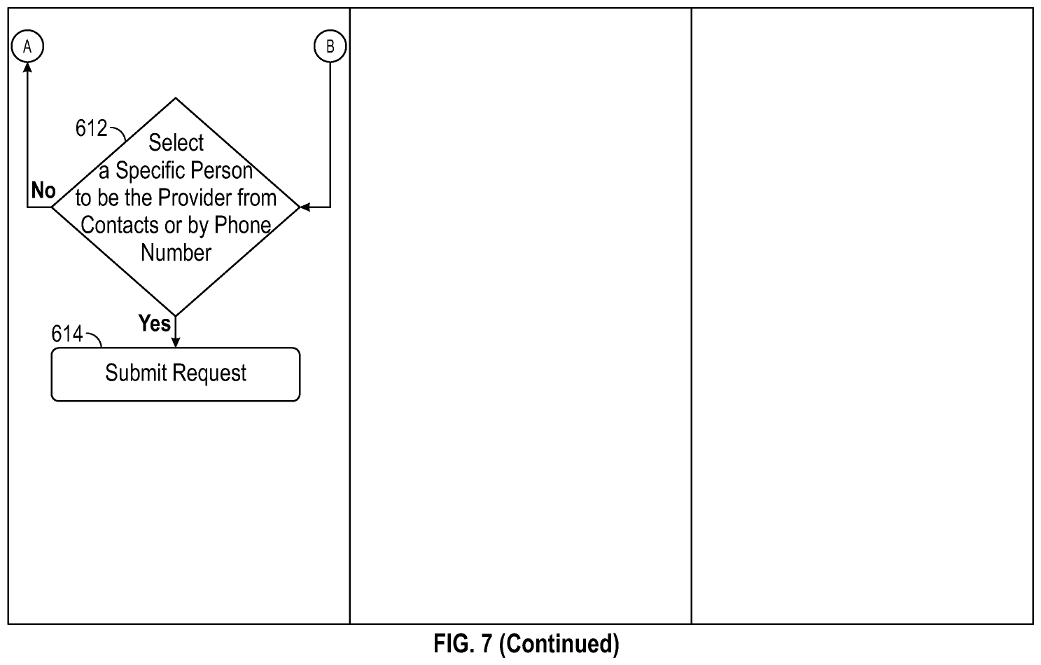

FIG. 7 shows an exemplary flow diagram 600 showing the steps implemented by the EENS platform presenting a Requester a Provider Selection Process in accordance with one non-limiting embodiment of the present invention. This is one process flow for enabling a Requester to select a Provider from a group of potential providers that are deemed available to fulfill the Requester's job (for example, based on those provider's being identified by the EENS as both available and in the vicinity of Target Location as determined the geo-fencing capabilities of the EENS). Thus, at step 602, using App 12 on device 10, Requester 2, makes a request for a media capture at a selected location and time/place. This media request at 602 triggers two decisions presented to the Requester via App 12 on her device 10. First, at step 608, Requester, via app 12, is presented with options to select a Provider based on skill sets and skill levels. If Requester decides to select an available provider based on skills, then at step 610 she submits her request. Else, as seen in the “No” line exiting decision box 608, the EENS assigns the Provider at step 604. Similarly, at step 612, Requester may be presented with the option to select a specific person as the Provider, from either a contact list or phone number list of potential providers. If she does opt to select the Provider based on these criteria, she at step 614 submits the request for this Provider. If not, as seen in the “No” line exiting decision box 612, the EENS assigns the Provider at step 604.

While embodiments of the invention have been illustrated and described, it is not intended that these embodiments illustrate and describe all possible forms of the invention. Various changes, modifications, and alterations in the teachings of the present invention may be contemplated by those skilled in the art without departing from the intended spirit and scope thereof. It is intended that the present invention encompass such changes and modifications.

What is claimed is:

1. A process using a digital audio-visual (A/V) content management system for on-demand, location-based capture and transmission of A/V content to a requester device associated with a requester that is subscribed to the system, comprising:
a. receiving a request from the requester device for A/V content to be captured at a location specified by the requester;
b. identifying, among a plurality of subscribed providers equipped with A/V capture devices that are networked to the system, a first provider that is suitable to perform the capture at the location, based at least in part on the location of the first provider relative to the location specified by the request;
c. offering the first provider to perform the capture at the selected location;
d. upon the first provider acceptance of the offer, receiving from the provider capture device an audio-visual feed from the requested location; and
e. sending the feed to the requester.

2. The process of claim 1, wherein the feed is a live audio-visual feed and the sending to the requester is done in real time.

3. The process of claim 1, further including the step of storing the feed in a server of the content management system.

4. The process of claim 3, wherein the sending of the visual feed to the requester is done at scheduled time.

5. The process of claim 1, wherein the step of identifying includes identifying a subset of providers among the plurality of providers that are suitable to perform the capture at the location, the step of offering includes offering the subset of providers to perform the capture, and the first provider is the first provider among the subset to accept the offer.

6. The process of claim 1, further including after the first provider accepts the offer and before the provider capture device captures the content, connecting the receiver device to the provider device.

7. The process of claim 1, wherein the request is for A/V content to be captured at a time specified by the requester device.

8. The process of claim 2, wherein the requester device directs the provider during the performance of the capture to manipulate the provider capture device according to instructions provided by the requester.

9. The process of claim 2, wherein using an application running on the requester device, the requester directs the provider during the performance of the capture to manipulate the provider capture device according to instructions provided by the requester device.

10. The process of claim 1, further including the steps of charging the requester a fee for the sending of the feed and paying the provider a pre-determined amount for the provision of the feed.

11. The process of claim 10, where the amounts charged to the requester and paid to the provider are at least partially negotiated by the requester and provider.

12. A networked, A/V content management system comprising at least one processor and a non-transitory computer-readable medium encoded with computer readable instructions, the management system for the capture and transmission of A/V content from at least one subscribed provider to at least one subscribed requester, wherein execution of said computer-readable instructions is configured to cause at least one central processor to execute steps comprising:
(a) obtaining subscribed requester information from computing devices of plural subscribed requesters;
(b) obtaining subscribed provider information from computing devices of plural subscribed providers;
(c) obtaining from a computing device of at least one of the plural subscribed requesters a request for the capture and transmission of A/V content at a location of interest to the at least one plural subscribed requester;
(d) selecting one of the plural subscribed providers having an A/V capture device in the vicinity of the location of interest as a candidate to fulfill the request;
(e) transmitting the request to the selected provider; and
(f) receiving, via the network, from the A/V capture device of the selected provider who accepted the request packetized A/V content captured by the device at the location of interest.

13. The system of claim 12, wherein execution of said computer-readable instructions is configured to cause at least one central processor to further execute the step of transmitting the captured packetized A/V content to a networked device of the requester.

14. A computer-implemented method for operating one or more servers to provide a service for arranging the provision of A/V captured content of and at a location of interest to a requester, the method comprising:
a. detecting a customer application executing on a computing device of a requester, the requester application automatically communicating with the service over a network;
b. receiving from the computing device of the requester, a request for the capture of the A/V content at a requester-specified location and time;
c. determining a current location of a plurality of available providers subscribed to the service, the current location of each available provider in the plurality of available providers being based on data determined by a corresponding provider application executing on a corresponding mobile computing device associated with that provider, wherein on each available provider in the plurality, the corresponding provider application executes to access a GPS resource of the corresponding mobile computing device in order to provide the data for determining the current location of that available provider to the service;
d. communicating with the requester application executing on the computing device of the requester to receive the A/V captured content; wherein communicating with the requester application includes:
i. providing data to the customer application executing on the mobile computing device to generate a presentation on a display of the mobile computing device of the customer, the presentation including a list of A/V capture options while concurrently providing a user interface feature from which the requester can trigger transmission of a request to initiate, by the one or more servers, a selection process to offer or assign the capture request to one of the plurality of providers;
ii. determining, from the plurality of available providers, one or more providers that satisfy criteria including at least of being within a designated proximity to the requested capture location;
iii. providing data to the requester application executing on the mobile computing device to cause the presentation to depict (i) the current location of the one or more providers that satisfy the criteria, and (iii) a predicted response time for the one or more providers that satisfies the criteria to arrive at the requested location;
e. in response to receiving the triggered transmission of the request from the user interface feature, initiating the selection process by programmatically selecting an available provider from the one or more providers to be assigned to execute an A/V content capture session, and then determining information to communicate to the provider application executing on the mobile computing device associated with the selected provider, the determined information including the location for the capture session; and
f. upon the provider arriving at the requested capture location, enabling the requester device application to communicate with the provider and provide A/V capture instruction.

15. The method of claim 14 further including the step of determining a fee for providing the A/V content to the requester, wherein the fee is based at least in part on the capture location.

16. The method of claim 14 further including the step of enabling the requester to view a live stream of the location from the provider's A/V capture computing device during the A/V content capture session.

17. The method of claim 14 further including the step of enabling the requester device to remotely control the A/V content capture session being captured by the provider device.
